(19) United States
(12) Patent Application Publication
(10) Pub. No.: US 2023/0411715 A1
(43) Pub. Date: Dec. 21, 2023

(54) BATTERY PACK

(71) Applicant: Samsung SDI Co., Ltd., Yongin-si (KR)

(72) Inventors: Hyeok Lee, Yongin-si (KR); Jaepil Ahn, Yongin-si (KR)

(21) Appl. No.: 18/212,074

(22) Filed: Jun. 20, 2023

(30) Foreign Application Priority Data
Jun. 21, 2022 (KR) 10-2022-0075677

(51) Int. Cl. H01M 10/48; H01M 10/42; H01M 50/543; H01M 50/204

(52) U.S. Cl. CPC H01M 10/482; H01M 10/425; H01M 50/543; H01M 50/204; H01M 2010/4271

(57) ABSTRACT

A battery pack includes: battery cells; and sensing units for acquiring state information of the battery cells. The sensing units include: sensing substrates extending in a first direction and having a first position at where sensing devices are positioned; and sensing terminals connected to the sensing substrates at a second position different from the first position and connected to the battery cells to acquire the state information. The sensing substrates and the sensing terminals overlap each other at the first and second positions in a second direction and extend to cross each other so that upper and lower positions are reversed in the second direction.

### CROSS-REFERENCE TO RELATED APPLICATION

This application claims priority to and the benefit of Korean Patent Application No. 10-2022-0075677, filed on Jun. 21, 2022, in the Korean Intellectual Property Office, the entire disclosure of which is incorporated herein by reference.

### BACKGROUND

### 1. Field

Aspects of embodiments of the present disclosure relate to a battery pack.

### 2. Description of the Related Art

Secondary batteries are designed to be charged and discharged, unlike primary batteries, which are not designed to be charged. Secondary batteries may be used as energy sources for mobile devices, electric vehicles, hybrid vehicles, electric bicycles, uninterruptible power supplies, etc. Secondary batteries may be used (or implemented) in the form of a single battery or in the form of a module (e.g., a battery module), in which multiple batteries are connected to each other and bundled into a single unit, depending on the type of external devices applied.

Because output voltage and/or output current may increase depending on the number of batteries connected together and how they are connected together (e.g., in series and/or in parallel), a single battery may be used to power small mobile devices, such as cell phones able to operate for a certain period of time with the output and capacity of a single battery, while a battery module may be used to power electric cars and hybrid cars, which require high power output for long-term and high power driving.

### SUMMARY

Embodiments of the present disclosure provides a battery pack including a sensing substrate provided as (or in the form of) a one-sided circuit board applied to form a sensing unit for collecting state information of a battery cell such that top and bottom surfaces of the sensing substrate may be laminated with a sensing device and a sensing terminal that extend to cross each other.

Additional aspects and features of the present disclosure will be set forth, in part, in the description that follows and, in part, will be apparent from the description or may be learned by practice of the embodiments of the present disclosure described herein.

According to an embodiment of the present disclosure, a battery pack includes: battery cells; and sensing units for acquiring state information of the battery cells. The sensing units include: sensing substrates extending in a first direction and having a first position at where sensing devices are positioned; and sensing terminals connected to the sensing substrates at a second position different from the first position and connected to the battery cells to acquire the state information. The sensing substrates and the sensing terminals overlap each other at the first and second positions in a second direction and extend to cross each other so that upper and lower positions are reversed in the second direction.

At the first position, the sensing substrate and the sensing terminal may be arranged at an upper position opposite to the battery cell and at a lower position facing the battery cell, respectively, and at the second position, the sensing substrate and the sensing terminal may be arranged at the lower position facing the battery cell and the upper position opposite the battery cell, respectively.

The sensing device may be on a top surface of the sensing substrate opposite to the battery cell.

At least one of the sensing substrate and the sensing terminal may include a deformable unit extending between upper and lower positions that are reversed at the first and second positions.

The deformable unit may connect the upper and lower positions that are reversed at the first and second positions in a stepped or inclined manner.

The sensing substrate may cross the sensing terminal and may include the deformable unit to connect a position higher than the sensing terminal at the first position and a position lower than the sensing terminal at the second position.

The sensing terminal may cross the sensing substrate and may include the deformable unit to connect a position lower than the sensing substrate at the first position and a position higher than the sensing substrate at the second position.

At a third position between the first and second positions in the first direction, the sensing substrate may have a through hole through which the sensing terminal passes to cross the sensing substrate.

The deformable unit may extend through the through hole.

In a third direction crossing the first and second directions, a periphery of the sensing substrate extending in the first direction around a periphery of the through hole may cross a through unit of the sensing terminal extending through the through hole.

At least one of the periphery of the through hole in the sensing substrate and the through unit of the sensing terminal may extend obliquely to connect the upper and lower positions that are reversed at the first and second positions and cross each other.

The periphery of the through hole in the sensing substrate and the through unit of the sensing terminal may cross each other while extending obliquely in opposite directions to connect the upper and lower positions that are reversed at the first and second positions.

The sensing substrate may be bonded to the sensing terminal by thermal compression or laminating.

The sensing substrate may extend from the first position to the second position in the first direction, and the sensing terminal may extend from the first position to a fourth position beyond the second position in the first direction.

The sensing terminal may be connected to the battery cell at the fourth position.

The sensing terminal may be connected to a terminal surface of the battery cell on which electrodes are formed.

The battery pack may further include a welding unit between the sensing terminal and the terminal surface of the battery cell.

The battery pack may further include a metal layer including a first bonding pad for connection between the sensing device and the sensing substrate is at the first position.

The battery pack may further include a first adhesive member coupling the sensing terminal and the sensing substrate is at the first position.

At the first position, the first bonding pad may be on a top surface of the sensing substrate opposite to the battery cell, and at the first position, the first adhesive member may be on a bottom surface of the sensing substrate facing the battery cell.

The battery pack may further include a metal layer including a second bonding pad coupling the sensing terminal and the sensing substrate at the second position.

The battery pack may further include a second adhesive member coupling the sensing terminal and the sensing substrate at the second position.

The battery pack may further include metal layers including first and second bonding pads connecting between the sensing device and the sensing terminal at the first and second positions respectively, and the first and second bonding pads may be on a top surface of the sensing substrate opposite to the battery cell.

The sensing substrate may be a one-sided circuit board that does not comprising a metal layer on a bottom surface facing the battery cell.

### BRIEF DESCRIPTION OF THE DRAWINGS

The above and other aspects and features of the present disclosure will be more apparent from the following description taken in conjunction with the accompanying drawings, in which:

FIG. 1 is an exploded perspective view of a battery pack according to an embodiment;

FIG. 2 is an exploded perspective view of a portion of the battery pack illustrated in FIG. 1;

FIG. 3 is a perspective view of a sensing unit illustrated in FIG. 2;

FIG. 4 is a cross-sectional view taken along the line IV-IV in FIG. 3;

FIGS. 5 and 6 are plan views schematically showing top and bottom surfaces of the sensing unit illustrated in FIG. 3, respectively;

FIG. 7 is a diagram showing assembly of the sensing unit illustrated in FIG. 3;

FIG. 8 is a perspective view of a sensing unit according to another embodiment;

FIGS. 9 and 10 are plan view schematically showing top and bottom surfaces of the sensing unit illustrated in FIG. 8, respectively; and

FIG. 11 is a cross-sectional view taken along the line XI-XI in FIG. 8.

### DETAILED DESCRIPTION

Reference will now be made in detail to embodiments, examples of which are illustrated in the accompanying drawings. In this regard, the described embodiments may have different forms and should not be construed as being limited to the descriptions set forth herein. Accordingly, embodiments are merely described below, by referring to the figures, to explain aspects and features of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, a battery pack according to embodiments of the present disclosure will be described with reference to the accompanying drawings.

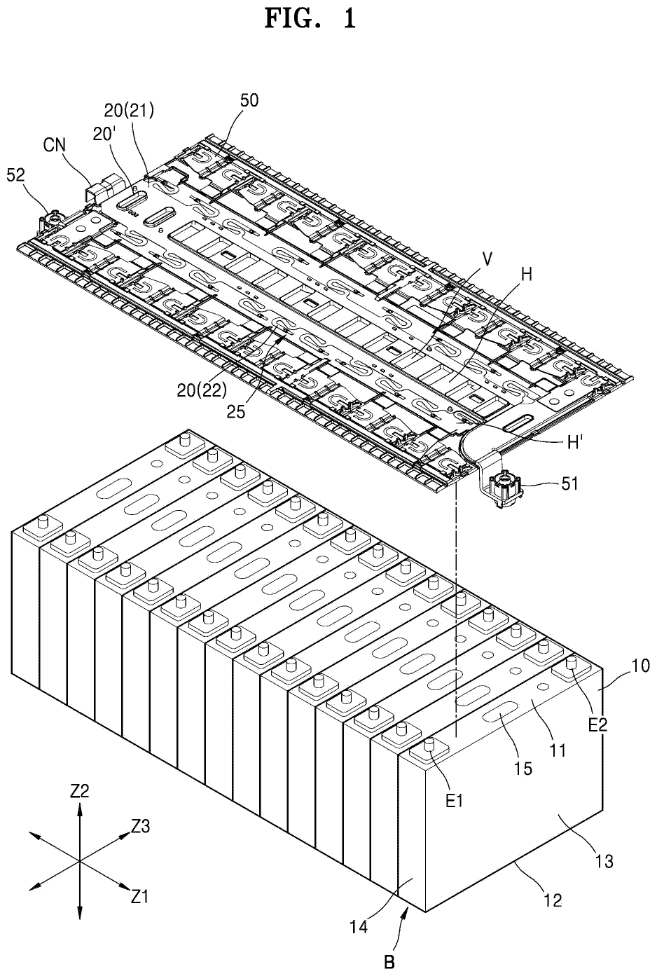

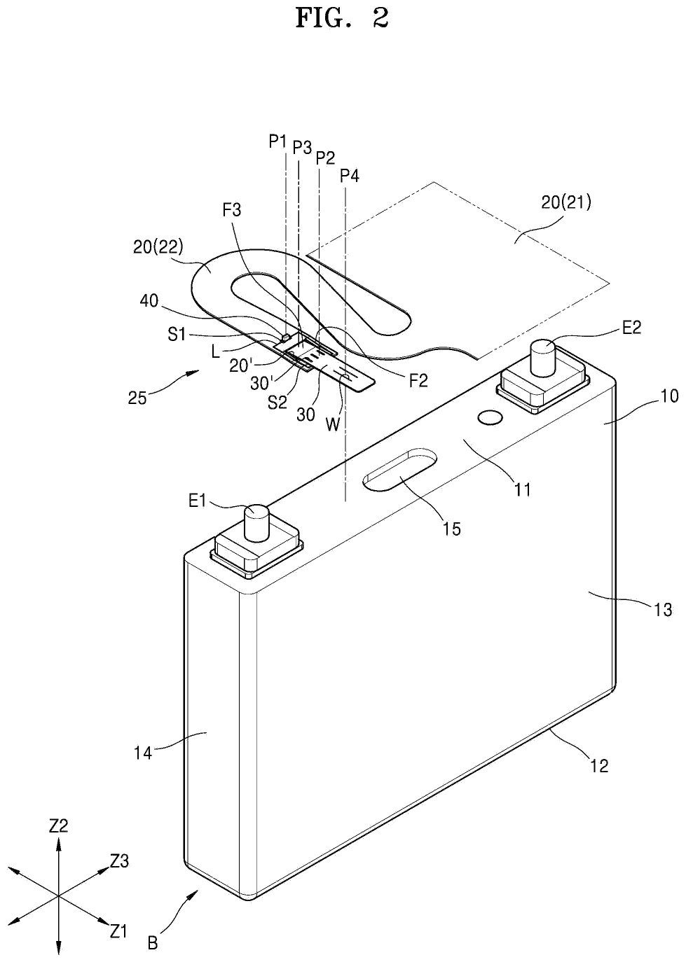

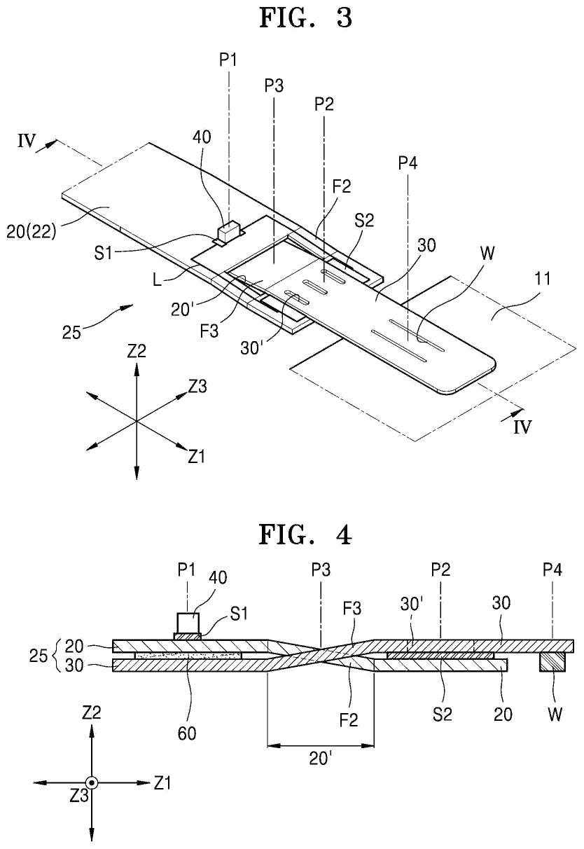

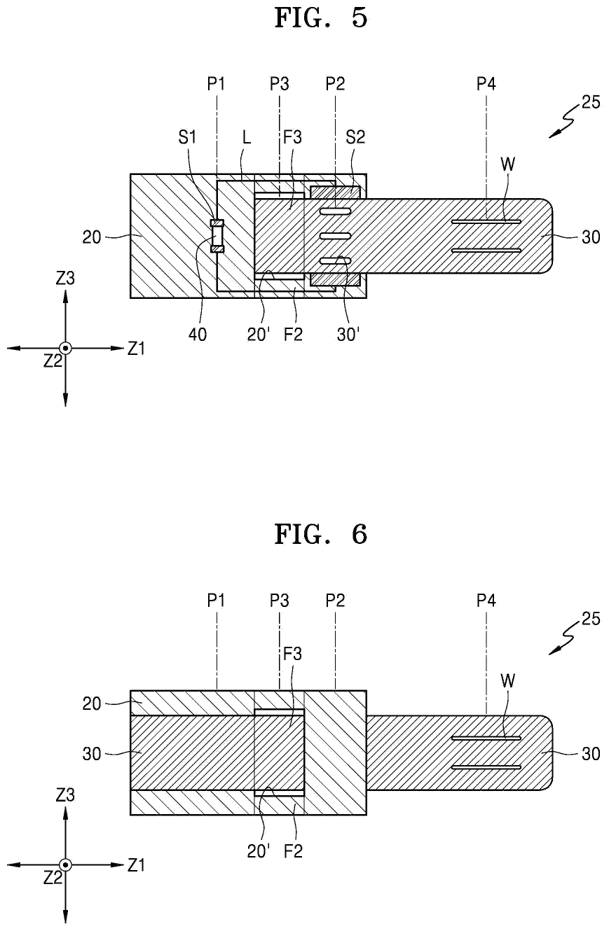

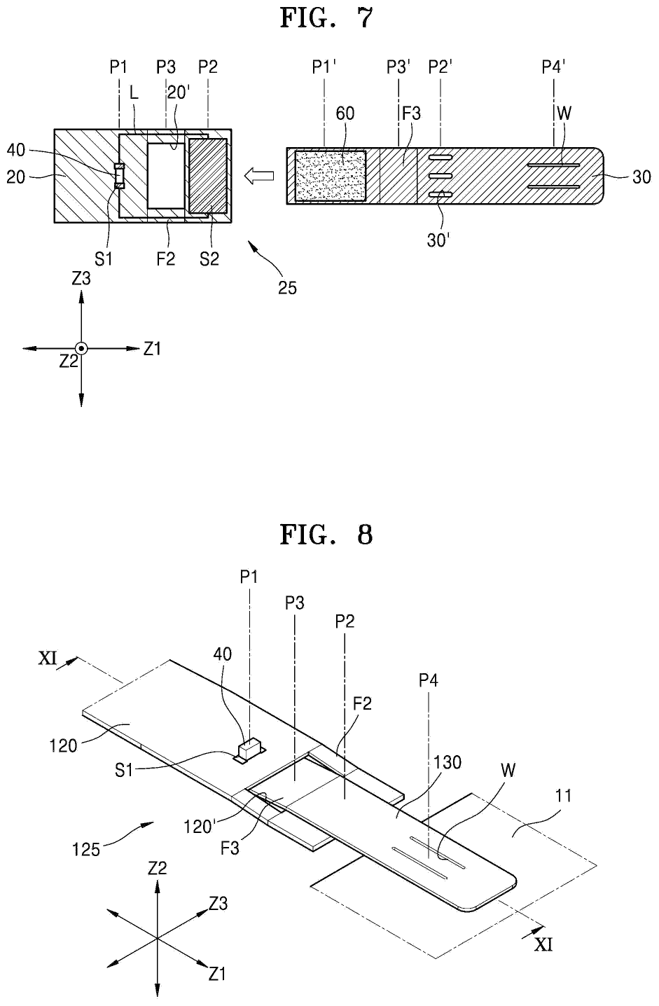

FIG. 1 is an exploded perspective view of a battery pack according to an embodiment, and FIG. 2 is an exploded perspective view of a portion of the battery pack illustrated in FIG. 1 showing the arrangement of sensing units and battery cells. FIG. 3 is a perspective view of the sensing unit illustrated in FIG. 2, FIG. 4 is a cross-sectional view taken along the line IV-IV in FIG. 3, and FIGS. 5 and 6 are plan views schematically showing top and bottom surfaces of the sensing unit illustrated in FIG. 3, respectively. FIG. 7 is a diagram showing assembly of the sensing unit illustrated in FIG. 3.

Referring to FIG. 1, a battery pack, according to an embodiment, may include a plurality of battery cells B arranged in a first direction Z1 and bus bars 50 disposed on the plurality of battery cells B to electrically connect different ones of the battery cells B to each other. In addition, bus bar holders H may be positioned between the bus bars 50 and the battery cells B for electrical insulation therebetween and to align the assembly position of the bus bars 50. Sensing substrates 20 for collecting state information of the battery cells B may be positioned on the bus bar holders H along with the bus bars 50. In an embodiment, the bus bars 50 may be connected to first and second electrode terminals E1 and E2, which have different polarities from each other, disposed on a terminal surface 11 of the battery cells B in a third direction Z3 crossing the first direction Z1. The first and second electrode terminals E1 and E2 may form first and second rows of electrode terminals E1 and E2 in the first direction Z1, and the bus bars 50 electrically connected to the first and second rows of electrode terminals E1 and E2 may form first and second rows of bus bars 50 on the first and second rows of electrode terminals E1 and E2. In addition, the sensing substrates 20 for collecting state information of the plurality of battery cells B may be provided (or arranged) between the first and second rows of electrode terminals E1 and E2 or between the first and second rows of bus bars 50. For example, the first and second rows of bus bars 50 and the sensing substrates 20 arranged therebetween may be supported and arranged on the bus bar holders H to align their assembly position and to insulate them from the battery cells B.

The battery cell B may have the terminal surface 11, on which the first and second electrode terminals E1 and E2 are formed, a bottom surface 12 opposite to the terminal surface 11, a wide side (e.g., a main surface) 13 covering a relatively large area, and a narrow side 14 covering a relatively small area. The sides 13 and 14 connecting (or extend between) the terminal surface 11 and the bottom surface 12. For example, the plurality of battery cells B arranged in the first direction Z1 may be positioned so that wide sides 13 face each other. A vent unit 15 may be formed on the terminal surface 11 of the battery cell B between the first and second electrode terminals E1 and E2 and may be configured to relieve (excess) internal pressure of the battery cell B, and vent holes (e.g., vent openings) V and 20′ may be respectively formed in the bus bar holder H and the sensing substrate 20 arranged on (or over) the vent unit to allow the flow of exhaust gas discharged through the vent unit 15 of the battery cell B therethrough. A connector CN electrically connected to the sensing substrate 20 may be formed at one end of the sensing substrate 20, and electrical connection between the sensing substrate 20 and a battery management system (BMS) may be provided through the connector CN. In an embodiment, in addition to the vent hole V, an opening H′ for exposing the sensing unit 25 including a connection unit 22 of the sensing substrate 20 to the terminal surface 11 of the battery cell B may be formed in the bus bar holder H.

The bus bars 50 may electrically connect different battery cells B to each other, and the plurality of bus bars 50 may be electrically connected to each other and electrically connected to (e.g., collectively electrically connected to) external devices through input/output terminals 51 and 52. The input/output terminals 51 and 52 may include a pair of different input/output terminals 51 and 52 connected to the battery cells at one end of the battery cell stack and the other end thereof and the bus bars connected to the battery cells at the one end and the other end to provide the electrical connection of the plurality of battery cells B to an external device. The external devices to which the plurality of battery cells B are connected through the input/output terminals 51 and 52 may correspond to external loads receiving discharge power from the battery pack or external chargers supplying charging power to the battery pack.

The sensing substrate 20 may include a body (e.g., a main body) 21 and the connection unit 22 branching from the body 21 toward different ones of the battery cells B. Throughout the description, the sensing substrate 20, which forms a portion of the sensing unit 25, may not refer to the body 21 of the sensing substrate 20 but may refer to the connection unit 22 branching from the body 21 of the sensing substrate 20 toward each battery cell B. Hereinafter, the sensing substrate 20 forming the sensing unit 25 is referred to as the sensing substrate 20 without being distinguished as the main body 21 and the connection unit 22. The sensing substrate 20, which forms the sensing unit 25, may refer to the connection unit 22 branching from the main body 21 of the sensing substrate 20 toward the battery cell B. In an embodiment, the connection unit 22 of the sensing substrate 20 may extend in a meandering serpentine (or ‘U’ or ‘S’) shape from the body 21 of the sensing substrate 20, and the connection unit 22 of the sensing substrate 20 may extend in a meandering shape to flexibly follow (or accommodate or absorb) the displacement of the battery cell B in the first direction Z1 due to the expansion and contraction of the battery cells B.

Hereinafter, with reference to FIGS. 2 to 7, the sensing unit 25 for collecting state information of a plurality of battery cells, according to an embodiment, will be described in more detail.

A battery pack, according to an embodiment, may include battery cells B and sensing units 25 for acquiring state information of the battery cells B. The sensing units 25 include sensing substrates 20, which extend in parallel in a first direction Z1 and have a first position (e.g., a first portion) P1 at where sensing devices 40 are formed, and a second position (e.g., a second portion) P2 different from the first position P1 at where sensing terminals 30 are connected to the sensing substrates 20 and connected to the battery cell B to acquire the state information. The sensing substrates 20 and the sensing terminals 30 overlap each other at the first and second positions P1 and P2 and extend to cross each other so that upper and lower positions are reversed in the second direction Z2 in which the sensing substrates 20 and the sensing terminals 30 overlap each other at the first and second positions P1 and P2.

In an embodiment, the sensing unit 25 may measure the state information, such as temperature, voltage, and current, of the battery cell B. For example, the sensing unit 25 including the sensing device 40, which may include or may be a thermistor which measures temperature by using the characteristic that resistance increases or decreases with temperature (e.g., a positive temperature coefficient thermistor (PTC) or negative temperature coefficient thermistor (NTC)) for sensing temperature of the battery cell B may generate and output electric signals corresponding to temperature information of the battery cell B.

In an embodiment, the sensing substrate 20 and the sensing terminal 30 may extend in parallel in the first direction Z1, and the first direction Z1 may correspond to a length direction of the sensing substrate 20 and/or the sensing terminal 30 throughout the description. For reference, throughout the description, the second direction Z2 may correspond to a thickness direction perpendicularly crossing the first direction Z1 or may refer to a thickness direction of each of the sensing substrate 20 and the sensing terminal 30 or a thickness direction of the entire sensing unit 25 including the sensing substrate 20 and the sensing terminal 30 assembled to each other. Throughout the description, upper and lower positions or higher and lower positions may refer to a position along the vertical direction following the second direction Z2 or a relative position along the vertical direction following the second direction Z2. As will be described later, each of the sensing substrate 20 and the sensing terminal 30 may have a bottom surface facing the battery cell B and a top surface opposite to the battery cell B. From among the different first and second positions P1 and P2 in the first direction Z1, at the first position P1, the sensing substrate 20 and the sensing terminal 30 may be positioned relatively at the upper position and the lower position, respectively. In other words, at the first position P1, the bottom surface of the sensing substrate 20 may face the top surface of the sensing terminal 30. Conversely, at the second position P2, the sensing substrate 20 and the sensing terminal 30 may be positioned at relatively lower and upper positions, respectively. In other words, the top surface of the sensing substrate 20 may face the bottom surface of the sensing terminal 30 at the second position P2.

As will be described later, the sensing substrate 20 and the sensing terminal 30, extending in parallel in the first direction Z1, may overlap in the second direction Z2 at the different first and second positions P1 and P2 in the first direction Z1 and may extend to cross each other so that the relative positions thereof in the second direction Z2 may be reversed at the first and second positions P1 and P2.

Throughout the description, the third direction Z3 is a direction crossing the first and second directions Z1 and Z2 and may refer to a width direction perpendicularly crossing the first and second directions Z1 and Z2. In addition, the first direction Z1 corresponding to the length direction and the third direction Z1 corresponding to the width direction may refer to the length direction and the width direction of the sensing substrate 20 and the sensing terminal 30, respectively, or the length direction and the width direction of the entire sensing unit 25 including the sensing substrate 20 and the sensing terminal 30 assembled to each other, respectively. As will be described later, in an embodiment, the sensing substrate 20 and the sensing terminal 30 extending in parallel in the first direction Z1 may extend to cross each other between the first and second positions P1 and P2 so that upper and lower positions are reversed at the different first and second positions P1 and P2 in the first direction Z1 and may cross each other through a through hole (e.g., an opening) 20′ formed at the third position P3 between the first and second positions P1 and P2 in the sensing substrate 20. The periphery of the through hole 20′ in the second direction Z2 in the sensing substrate 20 may cross a through unit of the sensing terminal 30 penetrating (e.g., extending through) the through hole 20′.

Throughout the description, that the sensing substrate 20 crosses the sensing terminal 30 may mean that the sensing terminal 30 is arranged to face the opposite bottom and top surfaces of the sensing substrate 20 at the first and second positions P1 and P2 in the first direction Z1. For example, the sensing terminal 30 may face the bottom surface of the sensing substrate 20 at the first position P1 while the sensing terminal 30 may face the top surface of the sensing substrate 20 at the second position P2. In an embodiment, the sensing terminal 30 may cross the sensing substrate 20 by penetrating (e.g., extending through) the sensing substrate 20 at the third position P3 between the first and second positions P1 and P2 so that the relative upper and lower positions of the sensing substrate 20 and the sensing terminal 30 at the first and second positions P1 and P2 are reversed. For example, that the sensing terminal 30 crosses the sensing substrate 20 may mean that, between the sensing terminal 30 and the sensing substrate 20, each having the opposite top and bottom surfaces, the sensing terminal 30 and the sensing substrate 20 are arranged so that the top surface of the sensing terminal 30 faces the bottom surface of the sensing substrate 20 at the first position P1 while the bottom surface of the sensing terminal 30 faces the top surface of the sensing substrate 20 at the second position P2. In other words, the sensing terminal 30 may be exposed to the bottom surface of the sensing substrate 20 at the first position P1, while the sensing terminal 30 may be exposed to the top surface of the sensing substrate 20 at the second position P2.

In an embodiment, the sensing terminal 30 and the sensing substrate 20 may each have opposite top and bottom surfaces in the second direction Z2, and the top and bottom surfaces of the sensing terminal 30 and the sensing substrate 20 may refer to opposite surfaces arranged in the same orientation. For example, the bottom surfaces of the sensing terminal 30 and the sensing substrate 20 may refer to surfaces relatively adjacent to (e.g., nearer to) the battery cell B or facing the battery cell B from among the opposite top and bottom surfaces in the second direction Z2, and the top surfaces of the sensing terminal 30 and the sensing substrate 20 may refer to surfaces relatively far from the battery cell B or opposite (e.g., facing away from) the battery cell B from among the opposite top and bottom surfaces in the second direction Z2. The sensing terminal 30 may be exposed to the bottom surface of the sensing substrate 20 at the first position P1 (e.g., disposed on the bottom surface of the sensing substrate 20) thereby leaving the top surface of the sensing substrate 20 as space for mounting the sensing device 40 at the first position P1 to allow connection of the sensing device 40 on the top surface of the sensing substrate 20 and to support the sensing substrate 20 where the sensing device 40 is formed. The sensing terminal may be exposed to the top surface of the sensing substrate 20 at the second position P2 different from the first position P1 to couple with the top surface of the sensing substrate 20.

According to an embodiment, because the sensing substrate 20 crosses the sensing terminal 30 and is provided as a one-sided circuit board, the opposite top and bottom surfaces of the sensing substrate 20 may be laminated with or coupled to the sensing device 40 and the sensing terminal 30. For example, at the first position P1, in the third direction Z3 from the bottom surface to the top surface of the sensing substrate 20, a laminate structure in which the sensing terminal 30, the sensing substrate 20, and the sensing device 40 are stacked may be formed. As will be described later, the sensing terminal 30 may provide an input side to which state information of the battery cell B is input while providing a coupling side with the battery cell B at a fourth position P4 at where the state information of the battery cell B may be transmitted to the sensing device 40 through the sensing terminal 30 extending from the second position P2 to the first position P1. The state information of the battery cell B converted into electrical signals through the sensing device 40 may be transmitted through the sensing substrate 20 electrically connected to the sensing device 40 to a battery management system (BMS) connected to one end of the sensing substrate 20.

According to an embodiment, the sensing substrate 20 may have opposite top and bottom surfaces in the second direction Z2. From among the opposite top and bottom surfaces, alternatively, a metal layer including bonding pads S1 and S2 for coupling with other components may be formed on the top surface of the sensing substrate 20 while the metal layer for coupling with other components may not be formed on the bottom surface of the sensing substrate 20 opposite to the upper surface. For example, the sensing substrate 20 may be soldered to the sensing device 40 at the first position P1 and soldered to the sensing terminal 30 at the second position P2 (e.g., at or through the coupling hole 30′ formed in the sensing terminal 30) through the metal layer including the first and second bonding pads S1 and S2 formed on the top surface of the sensing substrate 20.

In an embodiment, the sensing substrate 20 may be provided as a one-sided circuit board in which the metal layer including the first and second bonding pads S1 and S2 is formed on the top surface in the second direction Z2 and the metal layer is not formed on the bottom surface from among the opposite top and bottom surfaces. In this way, the sensing substrate 20 may be provided as a one-sided circuit board, and the sensing substrate 20 being a one-sided circuit board may have a different configuration from a double-sided circuit board in which metal layers are formed on the top and bottom surfaces thereof in the second direction Z2. For example, the one-sided circuit board may be formed through an easy process in a simplified form compared to the double-sided circuit board, thereby reducing the manufacturing cost.

In an embodiment, the sensing substrate 20 provided as a one-sided circuit board to reduce manufacturing cost by having a relatively simplified form is applied, and the sensing substrate 20 and the sensing terminal 30 extend to cross each other to be soldered to other components through the metal layer formed on the top surface of the sensing substrate 20 alternatively from among the top and bottom surfaces of the sensing substrate 20. Different from a double-sided circuit board with metal layers on both sides, the sensing substrate 20 is a one-sided circuit board having a metal layer formed on the top surface from among the top and bottom surfaces, and the opposite top and bottom surfaces of the sensing substrate 20 is laminated with the sensing device 40 and the sensing terminal 30.

In a comparative example, the sensing substrate 20 provided as a double-sided circuit board having metal layers on both the top and bottom surfaces is applied. For example, at a position corresponding to the first position P1, the sensing device 40 may be stacked on the top surface of the sensing substrate 20 and the sensing terminal 30 may be stacked on the bottom surface of the sensing substrate 20. However, different from the comparative example in which the sensing substrate 20 of the double-sided circuit board is applied, in an embodiment, the sensing substrate 20 of the one-sided circuit board having a relatively simple structure is applied, and a structure in which the sensing substrate 20 crosses the sensing terminal 30 is formed, thereby laminating the top and bottom surfaces of the sensing substrate 20 with the sensing device 40 and the sensing substrate 20, respectively.

In an embodiment, a laminate of the sensing device 40 and a laminate of the sensing terminal 30 may be formed on the opposite top and bottom surfaces of the sensing substrate 20. For example, the sensing device 40 and the sensing terminal 30 are formed on (e.g., are coupled to) the opposite top and bottom surfaces of the sensing substrate 20 so that the sensing terminal 30 may stably hold and support the sensing substrate 20 on which the sensing device 40 is formed. Because the sensing device 40 is arranged on the top surface of the sensing substrate 20 opposite to the battery cell B, rather than being arranged on the bottom surface of the sensing substrate 20 which faces the battery cell B, damage to the sensing device 40 due to impact with the battery cell B may be prevented.

In an embodiment, the sensing substrate 20 may form laminates of the sensing device 40 and the sensing terminal 30 through a metal layer formed on the top surface alternatively from among the bottom surface facing the battery cell B and the top surface opposite to the battery cell and may be provided as a one-sided circuit board in which a metal layer is formed on the top surface opposite to the battery cell B and is not formed on the bottom surface facing the battery cell B.

In an embodiment, the sensing substrate 20 and the sensing terminal 30 may extend to cross each other. Throughout the description, that the sensing substrate 20 crosses the sensing terminal 30 or the sensing substrate 20 and the sensing terminal 30 extend to cross each other may mean that the sensing substrate 20 and the sensing terminal 30 extend while crossing each other so that the upper and lower positions are reversed in the second direction Z2. For example, in an embodiment, the upper and lower positions of the sensing substrate 20 and the sensing terminal 30 may be reversed at the opposite first and second positions P1 and P2 in the first direction Z1. For example, while the sensing substrate 20 and the sensing terminal 30 may be arranged at the upper position and the lower position respectively in the second direction Z2 at the first position P1, the sensing terminal 30 and the sensing substrate may be arranged at the upper position and the lower position respectively at the second position P2.

In more detail about the intersection between the sensing substrate 20 and the sensing terminal 30, the sensing substrate 20 may cross the sensing terminal 30 at the third position (e.g., the third portion) P3 between the first and second positions P1 and P2 in the first direction Z1 and the sensing terminal 30 may extend through a through hole 20′ in the sensing substrate 20 formed at the third position P3 to cross the sensing substrate 20. For example, the sensing terminal 30 may extend from the lower position of (e.g., from below) the sensing substrate 20 at the first position P1 to the upper position of (e.g., to above) the sensing substrate 20 at the second position P2 through the through hole 20′ in the sensing substrate 20. The through hole 20′ in the sensing substrate 20 may provide an intersection between the sensing substrate 20 and the sensing terminal 30 where the intersection between the sensing substrate 20 and the sensing terminal 30 may correspond to a position at where a thickness centerline of the sensing substrate 20 crosses a thickness centerline of the sensing terminal 30 in the extension direction of the sensing substrate 20 and the sensing terminal 30 (e.g., where the sensing substrate 20 and the sensing terminal 30 cross in a cross-section view (see, e.g., FIG. 4)). For example, in an embodiment, the intersection between the sensing substrate 20 and the sensing terminal 30 may be made within (e.g., may occur in) the through hole 20′ in the sensing substrate 20 formed at the third position P3 between the first and second positions P1 and P2. The sensing substrate 20 and the sensing terminal 30 may be positioned at upper and lower positions, respectively, from the first position P1 to the third position P3 in the first direction Z1, and because the upper and lower positions are reversed at the third position P3 corresponding to the intersection, the sensing substrate 20 and the sensing terminal 30 are respectively positioned at the lower and upper positions from the third position P3 to the second position P2.

As such, in an embodiment, the sensing substrate 20 and the sensing terminal 30 may have positions that are reversed vertically at the first and second positions P1 and P2 and may form positions reversed vertically relative to each other. For example, along a level along the second direction Z2 from the terminal surface 11 of the battery cell B on which the sensing unit 25 including the sensing substrate 20 and the sensing terminal 30 is disposed, the sensing substrate 20 and the sensing terminal 30 may form different levels, respectively, at the first and second positions P1 and P2. For example, the sensing substrate 20 may extend from a high level at the first position P1 to a low level at the second position P2, and, conversely, the sensing terminal 30 may extend from the low level at the first position P1 to the high level at the second position P2. To this end, the sensing substrate 20 and the sensing terminal 30 may include deformable units (e.g., crossing portions or bent portions) F2 and F3, respectively, for connecting (e.g., extending between) different levels along the level following the second direction Z2 from the terminal surface 11 at the first and second positions P1 and P2, and the deformable units F2 and F3 of the sensing substrate 20 and the sensing terminal 30 connect different levels of the first and second positions P1 and P2 in a stepped or inclined manner. The first and second deformable units F2 and F3 of the sensing substrate 20 and the sensing terminal 30 continuously connect different levels of the first and second positions without disconnection of the sensing substrate 20 and the sensing terminal 30 between the first and second positions P1 and P2 and, to this end, may connect different levels of the first and second positions P1 and in a stepped or inclined manner. For example, the deformable units F2 and F3 may be formed between the first and second positions P1 and P2 of the sensing substrate 20 or the sensing terminal 30. Throughout the description, when it is assumed that the deformable units F2 and F3 connect the different levels of the first and second positions P1 and P2 in an inclined manner, the inclination may include not only an inclination of a certain angle but also an inclination of an angle that changes according to the extension direction of the sensing substrate 20 and the sensing terminal 30. In addition, the inclination may be extended linearly or curvedly.

In an embodiment, the deformable unit F2 of the sensing substrate 20 may be formed around (e.g., may extend around) the through hole 20′ extending in the first direction Z1 to surround the through hole 20′ at a position beyond the through hole 20′ in the third direction Z3 corresponding to the width direction of the sensing substrate 20. The deformable unit F3 of the sensing terminal 30 may be formed in (e.g., may extend through) the through hole 20′ in the sensing substrate 20. The sensing substrate 20 and the sensing terminal 30 may intersect (e.g., may cross each other) in the through hole 20′, and more specifically, the periphery of the through hole 20′ surrounding the through hole 20′ in the sensing substrate 20 may intersect the through unit (e.g., the deformable unit F3) penetrating (e.g., extending through) the through hole 20′ in the sensing terminal 30 to form the intersection. In an embodiment, the sensing terminal 30 may include a metal plate having excellent rigidity, and the sensing terminal 30 having excellent rigidity may be assembled with the sensing substrate 20 having low rigidity in a state in which the deformable unit F3 is formed in advance. The sensing substrate 20 may be flexibly deformed to correspond to the shape of the sensing terminal 30 and may adaptively respond to the shape of the sensing terminal to form the deformable unit F2. For example, the sensing terminal 30 having the deformable unit F3 formed in advance may be assembled to the sensing substrate 20 to pass through the through hole 20′ of the sensing substrate 20 and may be assembled to the sensing substrate 20 to locate the deformable unit F3 of the sensing terminal 30 in the through hole 20′ in the sensing substrate 20, and the deformable unit F2 may be formed around the through hole 20′ in the sensing substrate 20 to correspond to the shape of the sensing terminal 30. In an embodiment, the sensing substrate 20 may be provided as a flexible printed circuit board, and the deformation unit F2 may be formed around the through hole 20′, which may have excellent flexibility due to the through hole 20′ in the sensing substrate 20 in order to not damage the sensing substrate 20 due to lack of ductility of the sensing substrate 20. In some embodiments, the deformable units F2 and F3 of the sensing substrate 20 and the sensing terminal 30 may be formed in the process of bonding to each other through thermal compression or laminating after assembling the sensing substrate 20 and the sensing terminal 30. For example, while an assembly including the sensing terminal 30 inserted into the through hole 20′ in the sensing substrate 20 is thermally compressed or laminated in a flat shape, the deformable units F2 and F3 having corresponding shapes may be formed on the sensing substrate 20 and the sensing terminal 30.

As mentioned above, in an embodiment, each of the sensing substrate 20 and the sensing terminal 30 may form a different level from the terminal surface 11 of the battery cell B in the second direction Z2. One of the sensing substrate 20 and the sensing terminal 30 may form a different level at the first and second positions P1 and P2 while the other of the sensing substrate 20 and the sensing terminal 30 may form the same level at the first and second positions P1 and P2, thereby reversing the upper and lower positions of the sensing substrate 20 and the sensing terminal 30 at the first and second positions. For example, the sensing substrate 20 may form different levels at the first and second positions P1 and P2, while the sensing terminal 30 may form the same level at the first and second positions P1 and P2 (e.g., while the sensing terminal may be flat). For example, the sensing terminal 30 may include a relatively hard (e.g., rigid) metal plate, and the sensing terminal 30 of the metal plate having relatively high strength may include a flat metal plate forming the same level while the sensing terminal 30 forming the same level may extend across the lower position of the sensing substrate 20 and the upper position of the sensing substrate 20 at the same level. For example, the sensing terminal 30 having excellent rigidity passes through the through hole 20′, while the sensing terminal 30 may extend across the lower portion of the sensing substrate 20 at the first position P1 on one side of the through hole 20′. While the sensing terminal 30 extends across the upper portion of the sensing substrate 20 at the second position P2 of the other side of the through hole 20′, the deformation units F2 and F3 may be induced between the first and second positions P1 and P2 of the sensing substrate 20 having relatively low rigidity or flexibility. For example, the deformable unit F2 of the sensing substrate 20 may be formed around the through hole 20′ in the sensing substrate 20 extending in the first direction Z1 to surround the through hole 20′ at a position beyond the through hole 20′ in the third direction Z3 corresponding to the width direction of the sensing substrate 20. The periphery of the through hole 20′ in the sensing substrate 20 may cross the deformable unit penetrating the through hole 20′ in the sensing substrate 20, and the sensing substrate 20 and the sensing terminal 30 may intersect (e.g., may cross each other) in the through hole 20′.

In some embodiments, when one of the sensing terminal 30 and the sensing substrate 20 forms different levels at the first and second positions P1 and P2 and the other thereof forms the same level at the first and second positions P1 and P2, the sensing substrate 20 and the sensing terminal 30 may form positions in which they are vertically reversed. As mentioned above, in an embodiment, the sensing terminal 30 may form the same level at the first and second positions P1 and P2, while the sensing substrate 20 may form different levels at the first and second positions P1 and P2. In another embodiment, the sensing substrate 20 may form the same level at the first and second positions P1 and P2, but the sensing terminal 30 may form different levels at the first and second positions P1 and P2. For example, the deformable unit F3 may be formed in advance on the sensing terminal 30 having relatively high rigidity, and because the sensing terminal 30 is inserted into the through hole 20′ in the sensing substrate 20 so that the deformable unit F3 is located in the through hole 20′ in the sensing substrate 20, the sensing terminal 30 may extend across the lower and upper positions of the sensing substrate 20 formed at the same level. In this embodiment, the deformable unit F3 is formed in advance in the sensing terminal 30 having relatively high rigidity, and the sensing substrate 20 with relatively low rigidity assembled with the sensing terminal 30 may be prevented from being damaged during the assembly process. To prevent damage to the sensing substrate 20 when the sensing substrate 20, which has relatively low rigidity, is deformed following the shape of the sensing terminal 30, the sensing substrate 20 may maintain the same level at the first and second positions P1 and P2 and the deformable unit F3 may be formed in the sensing terminal 30 inserted into the through hole 20′ in the sensing substrate 20 instead of in the sensing substrate 20. In an embodiment, the intersection may be formed in the through hole 20′ at the third position P3 between the first and second position P1 and P2. For example, the through unit of the sensing terminal 30 penetrating the through hole 20′ may cross the periphery of the through hole 20′ extending in the first direction Z1 to surround the through hole 20′ at the position beyond the through hole 20′ in the third position Z3 corresponding to the width direction of the sensing substrate 20 in the through hole 20′.

In an embodiment, the third position P3 may be adjacent to the second position P2 in the first direction Z1. For example, the third position P3 providing the intersection may be adjacent to the second position P2 in which the sensing substrate 20 and the sensing terminal 30 whose upper and lower positions are reversed through the third position P3 are coupled. In other words, the second position P2 in which the sensing substrate 20 and the sensing terminal 30 beyond the through hole 20′ corresponding to the third position P3 are coupled may be formed adjacent to the through hole 20′ corresponding to the third position P3.

In an embodiment, the first and second positions P1 and P2 may respectively refer to positions where the sensing device 40 and the sensing terminal 30 are connected on the sensing substrate 20 in the first direction Z1. For example, in an embodiment, the first position P1 may refer to a position at where the sensing device 40 is connected to the sensing substrate 20, and the second position P2 may refer to a position at where the sensing terminal 30 is connected to the sensing substrate 20. For example, in an embodiment, the sensing device 40 and the sensing terminal 30 may form connections with the sensing substrate 20 at the different first and second positions P1 and P2, respectively, and the connections at first and second positions P1 and P2 may be formed through soldering. For example, in an embodiment, the connections at the first and second positions P1 and P2 may be formed through the metal layer formed on the top surface of the sensing substrate 20 from among the opposite top and bottom surfaces of the sensing substrate 20. In an embodiment, the sensing substrate 20 may be connected to the sensing device 40 and the sensing terminal 30 at the first and second positions P1 and P2 through the metal layers (e.g., through the first and second bonding pads S1 and S2) formed on the top surface alternatively from among the bottom surface facing the battery cell B and the top surface opposite to the battery cell B. In other words, by applying the sensing substrate 20 provided as the single-sided circuit board on which metal layers (e.g., the first and second bonding pads S1 and S2) are alternatively formed on the top surface, first and second positions P1 and P2 forming the connection on the upper surface of the sensing substrate 20 may be concurrently (or simultaneously) and collectively connected. For example, a connection with the sensing device 40 at the first position P1 and the sensing terminal 30 at the second position P2 may be collectively made through the metal layer (e.g., the first and second bonding pads S1 and S2) formed on the top surface of the sensing substrate 20 by using a soldering process, such as reflow soldering. In some embodiments, the connections at the first and second positions P1 and P2 may be made through various types of thermal bonding, including soldering. For example, the connection may be made by any thermal bonding capable of coupling the electrode of the sensing device 40 and the metal layer (e.g., the first bonding pad S1) of the sensing substrate 20 at the first position P1, and the connection may be made by any thermal bonding capable of coupling the sensing terminal 30 and the metal layer (e.g., the second bond pad S2) of the sensing substrate 20 at the second position P2.

In an embodiment, the sensing substrate 20 forming the coupling at the first and second positions P1 and P2 may be provided as a one-sided circuit board having metal layers (e.g., first and second bonding pads S1 and S2) formed on the top surface thereof from among the top and bottom surfaces of the sensing substrate 20 and may be provided as a flexible circuit board. Accordingly, in the soldering process, such as reflow soldering, a support base for firmly supporting the flexible circuit board may be provided, and in an embodiment, soldering performed at the first and second positions P1 and P2 on the sensing substrate 20 may be firmly supported through the sensing terminal 30, which supports the sensing substrate 20. For example, in an embodiment, the sensing terminal 30 positioned lower than the sensing substrate 20 at the first position P1 may firmly support the sensing substrate 20 on which the sensing device 40 is formed and may prevent the sensing device 40 having a relatively narrow soldering area from moving due to deformation or twisting due to the flexibility of the sensing substrate 20, thereby forming a robust electrical and physical connection between the sensing device 40 and the sensing substrate 20.

According to embodiments of the present disclosure, the connection at the first position P1 or lamination or formation between the sensing substrate 20 and the sensing device 40 at the first position P1 may mean a physical connection as well as an electrical connection comprehensively. For example, the sensing substrate 20 may be electrically connected to the sensing device 40, and the electrical signal about the state information of the battery cell B generated through the sensing device 40 may be transmitted through the sensing substrate 20. The state information of the battery cell B may be collected through a battery management system (BMS) connected to one end of the sensing substrate 20. Similarly, the connection at the second position P2 or lamination or formation between the sensing substrate 20 and the sensing terminal 30 may mean a physical connection. For example, the sensing substrate 20 may be coupled to the sensing terminal 30 through a physical connection.

In an embodiment, the coupling between the sensing substrate 20 and the sensing terminal 30 may be formed at the second position P2 and may also be formed at the first position P1. For example, according to an embodiment, the sensing unit 25 may include the sensing substrate 20 at where the sensing device 40 is formed and the sensing terminal 30, and the coupling between the sensing substrate 20 and the sensing terminal 30 may be formed at the first and second positions P1 and P2 in the first direction Z1. For example, the sensing substrate 20 (e.g., the second bonding pad S2 of the sensing substrate 20) and the sensing terminal 30 overlapping at the second position P2 may be coupled via a soldering material, and the sensing substrate 20 may be coupled to the sensing terminal 30 via a bonding member 60 at the first position P1. In an embodiment, a double-sided adhesive tape may be applied as the adhesive member 60. In an embodiment, the sensing substrate 20 and the sensing terminal 30 may extend in (e.g., may primarily extend in) the first direction Z1 as a longitudinal direction and may form a coupling at the different first and second positions P1 and P2 in the first direction Z1 so that the sensing substrate 20 is firmly coupled to the sensing terminal 30. For example, the sensing substrate 20 may be coupled to the sensing terminal 30 through the adhesive member 60 between the bottom surface of the sensing substrate 20 and the top surface of the sensing terminal 30 at the first position P1, and the coupling between the top surface of the sensing substrate 20 and the bottom surface of the sensing terminal 30 may be formed through a soldering material positioned therebetween at the second position P2.

In an embodiment, the sensing substrate 20 may include an insulating substrate and a metal layer formed on a surface of the insulating substrate (e.g., on a top surface of the insulating substrate opposite to the battery cell B). For example, the sensing substrate 20 may include a copper layer as the metal layer formed on a top surface of a polyimide substrate as the insulating substrate. The metal layer of the sensing substrate 20 may include the first bonding pad S1 formed in a shape corresponding to the electrode of the sensing device 40 at the first position P1 and the second bonding pad S2 formed with a sufficient area to cover the sensing terminal 30 at the second position P2 and, in an embodiment, may further include a conductive line L extending from the first bonding pad S1 connected to the electrode of the sensing device 40.

In an embodiment, while the sensing terminal 30 has structural rigidity superior to that of the sensing substrate 20 to stably support the sensing substrate 20, the sensing terminal 30 may include a metal material having excellent soldering characteristics with a metal layer (e.g., a copper layer) formed on the sensing substrate 20. For example, the sensing terminal 30 may include a metal plate extending in the first direction Z1. In one embodiment, the sensing terminal 30 may include a nickel plate. In an embodiment, the sensing terminal 30 extending from the first position P1 to the second position P2 in the first direction Z1 may be connected to the battery cell B at the fourth position P4 beyond the second position P2 and may transmit temperature information of the battery cell B as state information of the battery cell B from the second position P2 connected to the battery cell B to the first position P1 at where the sensing device 40 is arranged. To this end, the sensing terminal 30 may include a metal material having excellent thermal conductivity to sensitively acquire the state information of the battery cell B.

In an embodiment, a welding unit W may be formed between the sensing terminal 30 beyond the sensing substrate 20 and the battery cell B at the fourth position P4 opposite to the first position P1 based on the second position P2. In an embodiment, the sensing terminal 30 beyond the sensing substrate 20 may directly face the battery cell B and may be directly coupled to the battery cell B (e.g., to the lower surface of the sensing terminal 30) at the fourth position P4. For example, the sensing terminal 30 may be coupled to the battery cell B side through the welding unit W. For example, the welding unit W formed at the fourth position P4 may form a thermal and/or electrical connection between the sensing terminal 30 and the battery cell B forming a coupling to each other and may transmit information, such as temperature, voltage, and current as status information transmitted from the battery cell B through the welding unit W at the fourth position P4 to be converted to an electric signal related to the state information of the battery cell B and transmitted to the sensing substrate 20 through the sensing device 40 formed at the first position P1.

In an embodiment, the battery cell B or the battery cell B side, as a measurement point for measuring the state information of the battery cell B, may broadly mean, for example, a battery cell B itself or a configuration that is thermally and/or electrically connected to the battery cell B, and in an embodiment, may include the battery cell B itself or a bus bar electrically connected to the battery cell B. The bus bar which is a component that electrically connects different battery cells B to each other and may be thermally and/or electrically connected to the battery cell B to transmit state information of the battery cell B through the sensing terminal 30 to the sensing device 40.

In an embodiment, the sensing terminal 30 may be directly coupled to the battery cell B itself, and the sensing terminal 30 may be coupled to an outer surface of a case 10 forming an outer shape of the battery cell B. In an embodiment, the sensing terminal 30 may be coupled to the terminal surface 11 at where electrode terminals E1 and E2 are formed from among the outer surface of the case 10, and the terminal surface 11 to which the sensing terminal 30 is coupled may correspond to a position that is insulated from the electrode terminals E1 and E2 of the battery cell B and away from the charging and discharging path of the battery cell B. Because the state information of the battery cell B may be sensitively acquired away from Joule heating caused by the charging and discharging power of the battery cell B, a configuration in which the terminal surface 11 of the battery cell B is used as a measurement point may increase the reliability of the state information of the battery cell B compared to an embodiment in which the bus bar forming the charging and discharge path of the battery cell B is the measurement point.

For reference, in an embodiment, the battery cell B may include an internal electrode assembly, and the case 10 accommodates the internal electrode assembly. The case 10 may have main surfaces 13 facing each other between adjacent battery cells B in the first direction Z1 and may have the terminal surface 11 at where the electrode terminals E1 and E2 are formed, the bottom surface 12 opposite to the terminal surface 11, and side surfaces 14 connecting the terminal surface 11 and the bottom surface 12 and having a smaller area than the main surface 13.

In an embodiment, the sensing substrate 20 and the sensing terminal 30 forming the sensing unit 25 may extend to different lengths in the first direction Z1. For example, the sensing substrate 20 may extend from the first position P1 to the second position P2 in the first direction Z1 but may not extend to the fourth position P4 beyond the second position P2. In an embodiment, the sensing substrate 20 may extend from the first position P1 to the second position P2 in the first direction Z1. Different from the sensing substrate 20, the sensing terminal 30 may extend from the first position P1 to the fourth position P4 beyond the second position P2 in the first direction Z1 and may form a coupling with the battery cell B at the fourth position P4 beyond the sensing substrate 20. For example, in an embodiment, the sensing substrate 20 and the sensing terminal 30 forming the sensing unit 25 may be arranged to overlap each other from the first position P1 to the second position P2. However, the sensing substrate 20 having the through hole 20′ formed at the third position P3 may not overlap the sensing terminal 30 passing through the through hole 20′.

In an embodiment shown in FIG. 4, the sensing substrate 20 and the sensing terminal 30 forming the sensing unit 25 may be coupled through adhesion and thermal bonding at the first and second positions P1 and P2, respectively (e.g., through adhesion at the first position P1 and thermal bonding at the second position P2). For example, the adhesive member 60 may be disposed on the sensing terminal 30 disposed to face the sensing substrate 20 at the first position P1, and the bonding pad (e.g., the second bonding pad S2) may be formed on the sensing substrate 20 disposed to face the sensing terminal 30 at the second position P2. The bonding pad (e.g., second bonding pad S2) may correspond to the metal layer formed at the second position P2 of the sensing substrate 20. The sensing substrate 20 may include the first bonding pad S1 formed to correspond to the electrode of the sensing device 40 to be connected to the sensing device 40 at the first position P1 and the second bonding pad S2 having a large area covering the sensing terminal 30 to be connected to the sensing terminal 30 at the second position P2. The bonding pads S1 and S2 may correspond to metal layers formed on an insulating substrate forming the sensing substrate 20. The conductive line L, electrically connected to the bonding pads S1 and S2, may be further included in the insulating substrate in addition to the bonding pads S1 and S2.

FIG. 7 is a diagram showing assembly of the sensing unit 25 shown in FIG. 3. In FIG. 7, the sensing substrate 20 and the sensing terminal 30 forming the sensing unit 25 may be assembled to corresponding positions. For example, the sensing terminal 30 may be inserted into the through hole 20′ in the sensing substrate 20 so that the first to third positions P1, P2, and P3 of the sensing substrate 20 correspond to the first to third positions P1′, P2′, and P3′ of the sensing terminal 30. FIG. 7 shows that the first to third positions P1′, P2′, and P3′ of the sensing terminal 30 are aligned based on the first to third positions P1, P2, and P3 of the sensing substrate 20, but it is sufficient if the sensing substrate 20 of the first to third positions P1, P2, P3 and the sensing terminal 30 of the first to third positions P1′, P2′, P3′ are aligned through relative positioning. The sensing terminal 30 at the fourth position P4′ exposed from the third position P3 may be connected to the terminal surface 11 of the battery cell B.

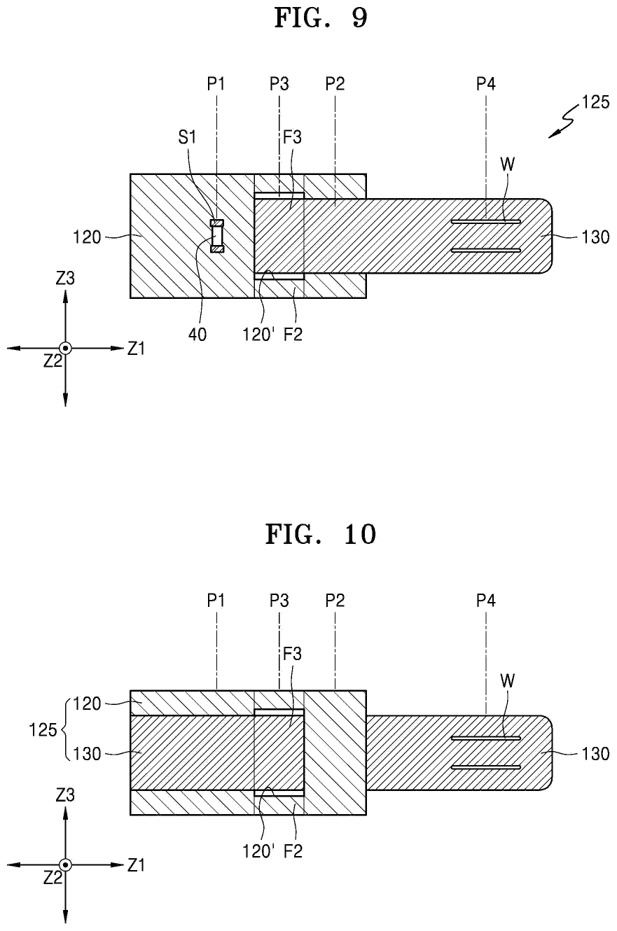

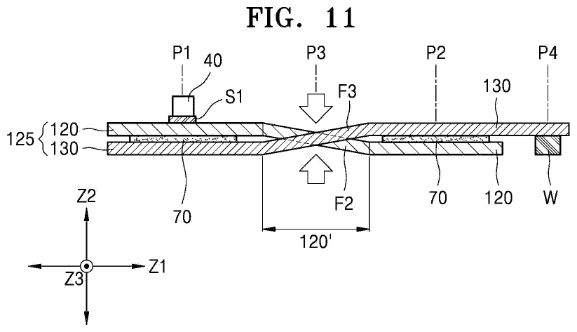

FIG. 8 is a perspective view of a sensing unit according to another embodiment. FIGS. 9 and 10 are diagrams respectively showing different top and bottom surfaces of the sensing unit shown in FIG. 8. FIG. 11 is a cross-sectional view taken along the line XI-XI of FIG. 8.

Hereinafter, a battery pack, according to another embodiment, will be described with reference to FIGS. 8 to 11. Referring to the FIGS. 8 to 11, the sensing substrate 120 and the sensing terminal 130 forming the sensing unit 125 may be coupled through thermal compression or laminating at the first and second positions P1 and P2. For example, in the first direction Z1, the sensing substrate 120 may overlap the sensing terminal 130 except at the third position P3 where the through hole 120′ is formed and at the fourth position P4 forming a coupling with the battery cell B. Thermal compression or laminating may be performed over the entire region at where the sensing substrate 120 may overlap the sensing terminal 130 in the first direction Z1. Accordingly, different from the embodiment shown in FIG. 4, in the embodiment shown in FIG. 11, a separate bonding pad (e.g., the second bonding pad S2 in FIG. 4) may not be formed at the second position P2 (e.g., the second bonding pad S2 may be omitted). An adhesive member 70 may be provided between the sensing terminal 130 and the sensing substrate 120, to which the thermal compression or laminating is performed, and the adhesive member 70 may be provided between the upper sensing substrate 120 and the lower sensing terminal 130 at the first position P1 and between the upper sensing terminal 130 and the lower sensing substrate 120 at the second position P2. However, other than the first and second positions P1 and P2, the adhesive member 70 may be formed throughout the area between the sensing substrate 120 and the sensing terminal 130 overlapping each other.

For example, while the coupling between the sensing substrate 20 and the sensing terminal 30 may be separately performed for each of the first and second positions P1 and P2 in the embodiment shown in FIG. 4, the coupling between the sensing substrate 120 and the sensing terminal 130 may be performed collectively at the first and second positions P1 and P2 in the embodiment shown in FIG. 11. For example, thermal compression or laminating may be collectively performed throughout the area between the sensing substrate 120 and the sensing terminal 130 overlapping each other both at the first and second positions P1 and P2.

According to embodiments of the present disclosure, a sensing unit for collecting state information of a battery cell may be formed by applying a one-sided circuit board with a relative low manufacturing cost, and by configuring the sensing circuit and sensing terminal to extend and cross each other, opposite top and bottom surfaces of the sensing substrate provided as the one-sided circuit board may be laminated with or coupled to the sensing device and the sensing terminal that extend to cross each other. In this way, by forming laminates of the sensing device and the sensing terminal on the opposite top and bottom surfaces of the sensing substrate, soldering between the sensing device and the sensing substrate may be stably supported by the sensing terminal. Further, according to embodiments of the present disclosure, by using a one-sided circuit board as a sensing substrate, soldering with sensing devices and soldering with sensing terminals may be collectively performed on one side of the sensing substrate.

According to embodiments of the present disclosure, because the sensing device is not disposed on the bottom surface of the sensing substrate facing the battery cell but is disposed on the top surface of the sensing substrate opposite to the battery cell, damage to the sensing device due to impact with the battery cell may be prevented.

It should be understood that the embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. A battery pack comprising:
battery cells; and
sensing units for acquiring state information of the battery cells, the sensing units comprising:
sensing substrates extending in a first direction and having a first position at where sensing devices are positioned; and
sensing terminals connected to the sensing substrates at a second position different from the first position and connected to the battery cells to acquire the state information,
wherein the sensing substrates and the sensing terminals overlap each other at the first and second positions in a second direction and extend to cross each other so that upper and lower positions are reversed in the second direction.

2. The battery pack of claim 1, wherein, at the first position, the sensing substrate and the sensing terminal are arranged at an upper position opposite to the battery cell and at a lower position facing the battery cell, respectively, and
wherein, at the second position, the sensing substrate and the sensing terminal are arranged at the lower position facing the battery cell and the upper position opposite the battery cell, respectively.

3. The battery pack of claim 1, wherein the sensing device is on a top surface of the sensing substrate opposite to the battery cell.

4. The battery pack of claim 1, wherein at least one of the sensing substrate and the sensing terminal comprises a deformable unit extending between upper and lower positions that are reversed at the first and second positions.

5. The battery pack of claim 4, wherein the deformable unit connects the upper and lower positions that are reversed at the first and second positions in a stepped or inclined manner.

6. The battery pack of claim 4, wherein the sensing substrate crosses the sensing terminal and comprises the deformable unit to connect a position higher than the sensing terminal at the first position and a position lower than the sensing terminal at the second position.

7. The battery pack of claim 4, wherein the sensing terminal crosses the sensing substrate and comprises the deformable unit to connect a position lower than the sensing substrate at the first position and a position higher than the sensing substrate at the second position.

8. The battery pack of claim 4, wherein, at a third position between the first and second positions in the first direction, the sensing substrate has a through hole through which the sensing terminal passes to cross the sensing substrate.

9. The battery pack of claim 8, wherein the deformable unit extends through the through hole.

10. The battery pack of claim 8, wherein, in a third direction crossing the first and second directions, a periphery of the sensing substrate extending in the first direction around a periphery of the through hole crosses a through unit of the sensing terminal extending through the through hole.

11. The battery pack of claim 10, wherein at least one of the periphery of the through hole in the sensing substrate and the through unit of the sensing terminal extends obliquely to connect the upper and lower positions that are reversed at the first and second positions and cross each other.

12. The battery pack of claim 10, wherein the periphery of the through hole in the sensing substrate and the through unit of the sensing terminal cross each other while extending obliquely in opposite directions to connect the upper and lower positions that are reversed at the first and second positions.

13. The battery pack of claim 1, wherein the sensing substrate is bonded to the sensing terminal by thermal compression or laminating.

14. The battery pack of claim 1, wherein the sensing substrate extends from the first position to the second position in the first direction, and
wherein the sensing terminal extends from the first position to a fourth position beyond the second position in the first direction.

15. The battery pack of claim 14, wherein the sensing terminal is connected to the battery cell at the fourth position.

16. The battery pack of claim 15, wherein the sensing terminal is connected to a terminal surface of the battery cell on which electrodes are formed.

17. The battery pack of claim 16, further comprising a welding unit between the sensing terminal and the terminal surface of the battery cell.

18. The battery pack of claim 1, further comprising a metal layer comprising a first bonding pad for connection between the sensing device and the sensing substrate is at the first position.

19. The battery pack of claim 18, further comprising a first adhesive member coupling the sensing terminal and the sensing substrate is at the first position.

20. The battery pack of claim 19, wherein, at the first position, the first bonding pad is on a top surface of the sensing substrate opposite to the battery cell, and
wherein, at the first position, the first adhesive member is on a bottom surface of the sensing substrate facing the battery cell.

21. The battery pack of claim 1, further comprising a metal layer comprising a second bonding pad coupling the sensing terminal and the sensing substrate at the second position.

22. The battery pack of claim 1, further comprising a second adhesive member coupling the sensing terminal and the sensing substrate at the second position.

23. The battery pack of claim 1, further comprising metal layers comprising first and second bonding pads connecting between the sensing device and the sensing terminal at the first and second positions respectively, and
wherein the first and second bonding pads are on a top surface of the sensing substrate opposite to the battery cell.

24. The battery pack of claim 23, wherein the sensing substrate is a one-sided circuit board that does not comprising a metal layer on a bottom surface facing the battery cell.
